(19) United States
(12) Patent Application Publication
(10) Pub. No.: US 2009/0177473 A1
(43) Pub. Date: Jul. 9, 2009

(54) APPLYING VOCAL CHARACTERISTICS FROM A TARGET SPEAKER TO A SOURCE SPEAKER FOR SYNTHETIC SPEECH

(76) Inventors: Andrew S. Aaron, Ardsley, NY (US); Ellen Marie Eide, Tarrytwon, NY (US); Raul Fernandez, New York, NY (US)

Correspondence Address: WOLF GREENFIELD & SACKS, P.C., 600 ATLANTIC AVENUE, BOSTON, MA, 02210-2206, US

(21) Appl. No.: 11/970,282

(22) Filed: Jan. 7, 2008

(51) Int. Cl. G10L 13/00

(52) U.S. Cl. 704/260; 704/E13.01

(57) ABSTRACT

A computer implemented method, system and computer usable program code for synthesizing speech. A computer implemented method for synthesizing speech includes providing a database of speech of a source speaker, and providing a prosody model of speech of a target speaker different from the source speaker. Text input to be synthesized is received, and the prosody model of speech of the target speaker is applied to the text input to select segments of the speech of the source speaker in the database to form synthesized speech of the text input. The synthesized speech of the text input is then output.

### BACKGROUND OF THE INVENTION

1. Field of the Invention

The present invention relates generally to the data processing field and, more particularly, to a computer implemented method, system and computer usable program code for synthesizing speech.

2. Description of the Related Art

Current speech synthesis systems use “Concatenative Text-to-Speech” (CTTS), a technique in which a large database of natural speech is recorded and subsequently automatically segmented into very small pieces which can be reassembled to form words and phrases that are not present in the original recordings.

While speech synthesis systems employing CTTS are capable of extremely high-quality synthetic speech output, building a high-quality system requires a large database of natural speech to be recorded which can be quite expensive and time consuming.

Consider a situation in which a potential user of a CTTS speech synthesis system wishes to use a particular voice talent in the system, but does not have sufficient recordings of the voice talent to create a proper database to produce a synthetic speech output of sufficient quality, i.e., to allow for speaking arbitrary text. However, the voice talent may not be available to supplement the existing recordings, or, even if the voice talent is available, the potential user may not wish to incur the expense of a massive recording project required to supplement the existing recordings to construct a database appropriate for building a high-quality CTTS system. In such a situation, the potential user could profit from the ability to adapt an off-the-shelf CTTS voice synthesis system to sound like the particular voice talent.

Unfortunately, adapting the voice of a source speaker, for example, a speaker that might have been used in an off-the-shelf CTTS voice synthesis system, to that of a target speaker, for example, a desired voice talent, using known signal processing techniques has proven difficult. While signal processing can alter the tone of a voice, the processing tends to introduce an unpleasant processed quality which sounds unnatural and which degrades the quality of the voice. The greater the difference between the voices of the source and target speakers, the more signal processing that is required and the more this unnatural, processed quality builds up.

There is, accordingly, a need for an improved mechanism for adapting the voice of a source speaker to sound like the voice of a target speaker in a speech synthesis system such as a CTTS speech synthesis system.

### SUMMARY OF THE INVENTION

Exemplary embodiments provide a computer implemented method, system and computer usable program code for synthesizing speech. A computer implemented method for synthesizing speech includes providing a database of speech of a source speaker, and providing a prosody model of speech of a target speaker different from the source speaker. Text input to be synthesized is received, and the prosody model of speech of the target speaker is applied to the text input to select segments of the speech of the source speaker in the database to form synthesized speech of the text input. The synthesized speech of the text input is then output.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an exemplary embodiment when read in conjunction with the accompanying drawings, wherein:

FIG. 1 depicts a pictorial representation of a network of data processing systems in which exemplary embodiments may be implemented;

FIG. 2 illustrates a block diagram of a data processing system in which exemplary embodiments may be implemented;

FIG. 3 is a block diagram that illustrates a concatenative text-to-speech synthesis system according to an exemplary embodiment;

FIG. 4 is a flowchart that illustrates a method for synthesizing speech to assist in explaining exemplary embodiments; and

FIG. 5 is a flowchart that illustrates a method for synthesizing speech according to an exemplary embodiment.

### DETAILED DESCRIPTION OF THE PREFERRED EMBODIMENT

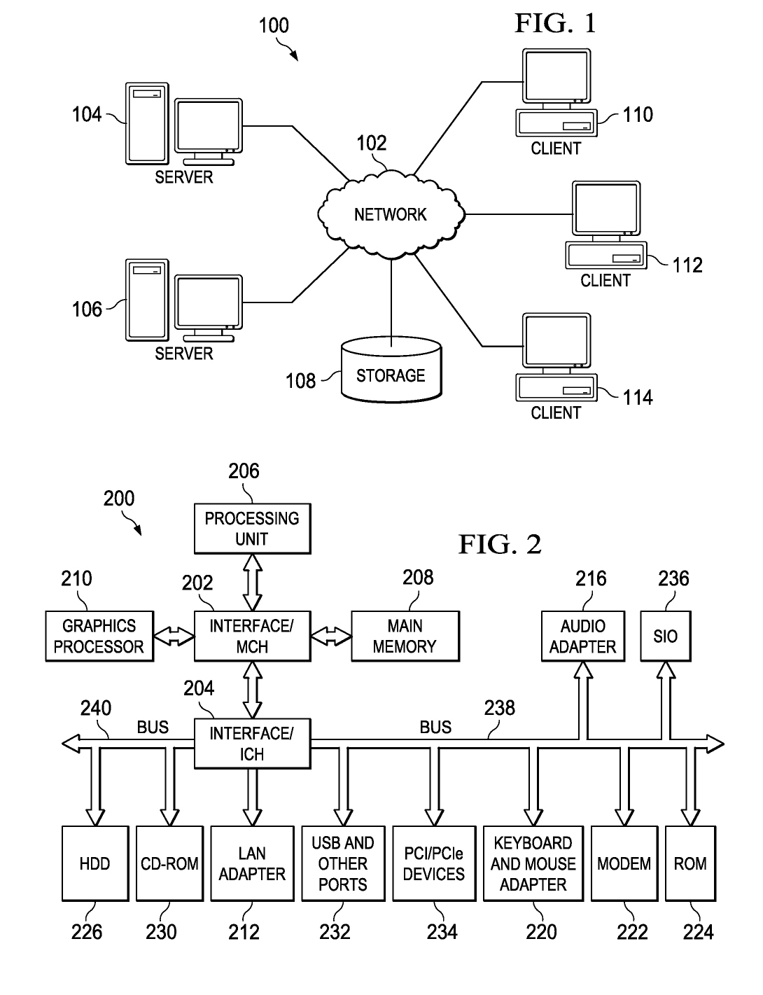

With reference now to the figures and in particular with reference to FIGS. 1-2, exemplary diagrams of data processing environments are provided in which exemplary embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

With reference now to FIG. 2, a block diagram of a data processing system is shown in which illustrative embodiments may be implemented. Data processing system 200 is an example of a computer, such as server 104 or client 110 in FIG. 1, in which computer usable program code or instructions implementing the processes may be located for the exemplary embodiments.

In the depicted example, data processing system 200 employs a hub architecture including interface and memory controller hub (interface/MCH) 202 and interface and input/output (I/O) controller hub (interface/ICH) 204. Processing unit 206, main memory 208, and graphics processor 210 are coupled to interface and memory controller hub 202. Processing unit 206 may contain one or more processors and even may be implemented using one or more heterogeneous processor systems. Graphics processor 210 may be coupled to the interface/MCH through an accelerated graphics port (AGP), for example.

In the depicted example, local area network (LAN) adapter 212 is coupled to interface and I/O controller hub 204 and audio adapter 216, keyboard and mouse adapter 220, modem 222, read only memory (ROM) 224, universal serial bus (USB) and other ports 232, and PCI/PCIe devices 234 are coupled to interface and I/O controller hub 204 through bus 238, and hard disk drive (HDD) 226 and CD-ROM 230 are coupled to interface and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE) or serial advanced technology attachment (SATA) interface. A super I/O (SIO) device 236 may be coupled to interface and I/O controller hub 204.

An operating system runs on processing unit 206 and coordinates and provides control of various components within data processing system 200 in FIG. 2. The operating system may be a commercially available operating system such as Microsoft® Windows Vista™ (Microsoft and Windows Vista are trademarks of Microsoft Corporation in the United States, other countries, or both). An object oriented programming system, such as the Java™ programming system, may run in conjunction with the operating system and provides calls to the operating system from Java™ programs or applications executing on data processing system 200. Java™ and all Java™-based trademarks are trademarks of Sun Microsystems, Inc. in the United States, other countries, or both.

Instructions for the operating system, the object-oriented programming system, and applications or programs are located on storage devices, such as hard disk drive 226, and may be loaded into main memory 208 for execution by processing unit 206. The processes of the illustrative embodiments may be performed by processing unit 206 using computer implemented instructions, which may be located in a memory such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the exemplary embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in interface and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

Exemplary embodiments provide a computer implemented method, system and computer usable program code for synthesizing speech. More particularly, exemplary embodiments provide a computer implemented method, system and computer usable program code for adapting the voice of a source speaker to sound like the voice of a target speaker in a speech synthesis system such as a Concatenative Text-to-Speech (CTTS) speech synthesis system.

Exemplary embodiments are particularly suitable for situations in which a potential user of a CTTS speech synthesis system wishes to use a particular voice talent in the system, but does not have sufficient recordings of the voice talent to create a proper database to produce a speech output of sufficient quality, i.e., to allow for speaking arbitrary text. However, the voice talent may not be available to supplement the existing recordings, or, even if the voice talent is available, the potential user may not wish to incur the expense of a massive recording project required to supplement the existing recordings to construct a database appropriate for building a high-quality CTTS system. In such a situation, the potential user could profit from the ability to adapt an off-the-shelf CTTS voice synthesis system to sound like the particular voice talent.

Exemplary embodiments recognize that an alternative approach to supplementing an existing database is to utilize the voice of a different speaker as a source speaker and to adapt the voice of the source speaker to sound like the existing voice talent (target speaker) such that the synthesized speech will sound like the existing voice talent. For example, by adapting an off-the-shelf CTTS voice synthesis system to produce synthetic speech that sounds like the existing voice talent, the time and expense required to develop a satisfactory database can be significantly reduced.

Altering the voice of a source speaker to sound like that of a target speaker using known signal processing techniques is not fully satisfactory because the processing tends to introduce an unpleasant processed quality which sounds unnatural and which degrades the quality of the voice. Exemplary embodiments provide a computer implemented method, system and computer usable program code for synthesizing speech in which the synthetic speech output of an off-the-shelf CTTS voice synthesis system is biased to sound similar to a target voice without requiring significant signal processing and without introducing undesirable distortions.

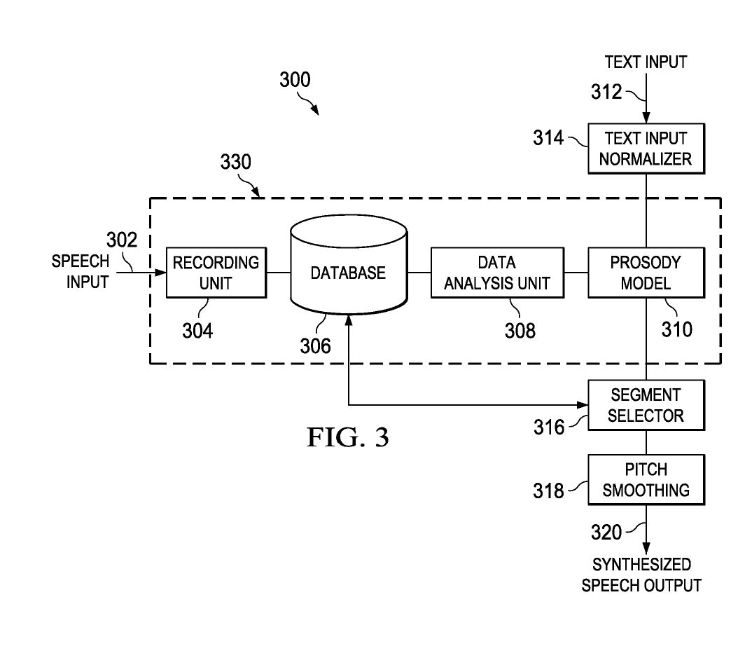

FIG. 3 is a block diagram that illustrates a concatenative text-to-speech (CTTS) voice synthesis system according to an exemplary embodiment. The system is generally designated by reference number 300, and may be implemented in a data processing system such as data processing system 200 in FIG. 2. CTTS system 300 includes recording unit 304 for receiving and recording an input speech 302 provided by a source speaker, and a database 306 for storing one or more recordings of the input speech. Consider that the source speaker is a person named “Susan”.

In order to develop a CTTS voice, it is necessary to build a statistical prosody model that infers generalities about the speech input. Such generalities may include, for example, the rise and fall of pitch, and the duration and the loudness of the speech input. The statistical prosody model “learns” these generalities by analyzing the recorded speech stored in database 306 using data analysis unit 308. A prosody model of the source speaker's voice is built as shown at 310, and prosody model 310 is then used as a guide for constructing a synthetic speech output.

For example, consider that when Susan recorded her database she emphasized words by increasing their durations (rather than by increasing their pitch or volume). This information will be identified by data analysis unit 308 and incorporated into Susan's statistical prosody model 310. Recording unit 304, database 306, data analysis unit 308 and prosody model 310 are sometimes referred to herein as source speaker system 330.

In order to synthesize text, the text to be synthesized is input as shown at 312. After being normalized by text input normalizer unit 314, prosody model 310 is applied to the text. Segments of the source speaker's voice are then selected from database 306 by segment selector unit 316 to match the source speaker's features, and after smoothing the pitch by pitch smoothing unit 318, synthesized speech is output from the system as shown at 320.

Consider, for example, that the text input 312 to be synthesized is a word that requires emphasis, such as, for example, the word “extremely.” In such a situation, synthesized speech output 320 will follow Susan's prosody model and increase its duration. In other words, the system will bias the segment selection process to favor long durations. This feature becomes recognizable as part of the inherent “Susan-ness” of her speech.

Continuing the above example, assume that a working “Susan” speech synthesis system is available, but that a potential user desires a speech synthesis system that utilizes the voice of a particular voice talent “Helen”. Although it may be possible to use signal processing techniques to process Susan's voice to sound like Helen, this can only be done to a limited extent before unpleasant effects are encountered.

Assume, however, that the potential user has enough of Helen's speech to make a prosody model of Helen's voice. According to an exemplary embodiment, a prosody model of Helen's speech is built using the available samples of Helen's speech, and Helen's prosody model is then applied to Susan's speech. In particular, prosody model 310 in FIG. 3 is now Helen's prosody model rather than Susan's. As a result, when Helen's prosody model is applied to Susan's speech, features of Helen's speech, for example, the pitch, pitch range, durations, parsing patterns, rhythmic quality and voice qualities such as breathiness or nasality, of Helen's speech is applied to Susan's voice. As a result, segment selector unit 318 will be biased to find Helen-like segments of Susan's speech when searching database 306.

Biasing the database search, possibly in conjunction with some signal processing that will increase the “Helenness” a little more but not enough to incur unnatural, processed qualities, results in synthesized speech output 320 sounding like Helen's voice although it was created from Susan's voice. In general, the more of Helen's voice that is available to create a prosody model of Helen's voice, the more the synthesized speech output will sound like Helen's voice.

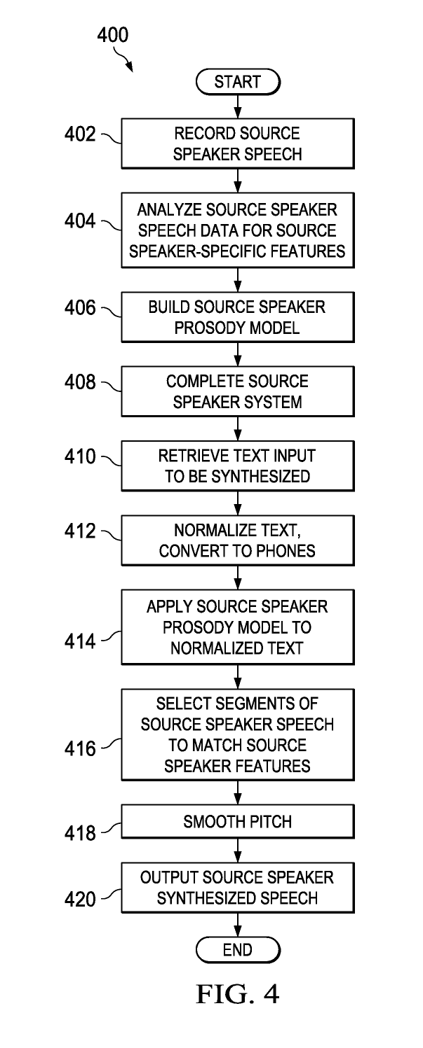

FIG. 4 is a flowchart that illustrates a method for synthesizing speech to assist in explaining exemplary embodiments. The method is generally designated by reference number 400, and begins by recording the voice of a source speaker to provide source voice data that will be used to synthesize speech (Step 402). The source speaker voice data is then analyzed for source speaker-specific features (Step 404). Such source speaker-specific features may, for example, include intonation, duration and the like.

A source speaker prosody model is then built (Step 406), and a source speaker system is completed (Step 408) In this step are included any parts of the database-building process that are independent of the target-speaker characterization described here, and include things like keeping inventory of the source-speaker's acoustic units, locations of glottal pulses in the source-speaker's speech database, etc.

Text input to be synthesized is then received (Step 410), and is normalized and converted to phones (Step 412). The source speaker prosody model that was built in Step 406 is then applied to the normalized text input (Step 414). Segments of the source speaker's voice that match the source speaker's features as specified by the prosody model are selected to create synthesized speech of the text input (Step 416). Pitch smoothing processes are then applied to the synthesized speech (Step 418), and synthesized speech of the text input is output (Step 420).

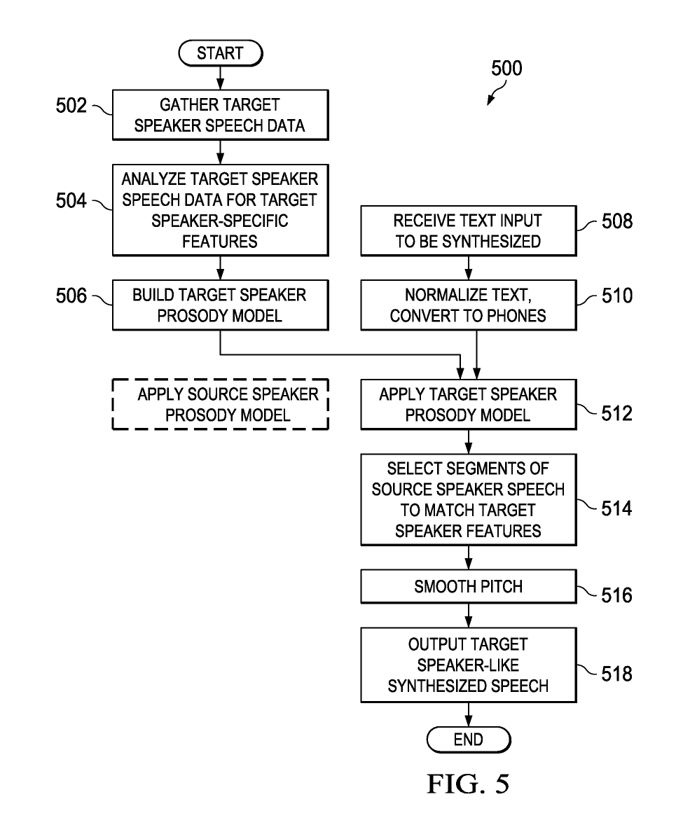

FIG. 5 is a flowchart that illustrates a method for synthesizing speech according to an exemplary embodiment.

The method is generally designated by reference number 500, and assumes that a source speaker system, such as source speaker system 330 illustrated in FIG. 3 has already been created using a source speaker voice as described in connection with Steps 402 to 408 in the flowchart illustrated in FIG. 4. Such a source speaker system may, for example, be incorporated in an off-the-shelf CTTS speech synthesis system.

The method begins by acquiring one or more samples of a target speaker's speech (Step 502), the target speaker's speech being the speech of a second speaker, different from the source speaker, that it is desired to emulate in a speech synthesis system. As indicated previously, a user may have some recordings of the target speaker but not a sufficient amount to create a database adequate to develop a high quality synthesized speech output. The samples of the target speaker's speech are analyzed for target speaker-specific speech features (Step 504). Target speaker-specific speech features may include features such as the rise and fall of the target speaker's pitch, the duration for voicing words, loudness and the like. In general, the analysis is looking for features of the target speaker's voice that help distinguish the target speaker from other speakers.

After analysis of the target speaker's speech, a target speaker prosody model is built (Step 506).

At runtime, text input to be synthesized is received (Step 508), and the text input is normalized and converted to phones (Step 510) in a similar manner as described with reference to FIG. 4. At this point, however, rather than applying a prosody model of the source speaker to the text input to be synthesized, as in the method described in FIG. 4, the CTTS system applies the prosody model of the target speaker to the text input (Step 512), and selects segments from the source speaker's voice to match the target speakers' speech by using the target speaker's prosody model rather than the source speaker's prosody model (Step 514). Pitch smoothing is applied (Step 516) and synthesized speech of the text input is output (Step 518).

Because the synthesized speech that is output in Step 518 was created using the target speaker's prosody model, the synthesized speech will resemble the voice of the target speaker even though the synthesized speech was generated using the source speaker's voice. As a result, the user is provided with a CTTS voice synthesis system that generates synthesized speech that sounds similar to the voice of a desired speaker, but that uses the voice of a different source speaker to synthesize the speech.

Exemplary embodiments, in effect, help a listener perceive that the listener is hearing the target speaker by having the CTTS system automatically annotate and then retrieve at run time speech characteristics and patterns of the source speaker that best match the intended target speaker. Although some amount of signal transformation may still be desired, the amount may be reduced, thus mitigating the degradation introduced by such transformation.

Exemplary embodiments thus provide a computer implemented method, system and computer usable program code for synthesizing speech. A computer implemented method for synthesizing speech includes providing a database of speech of a source speaker, and providing a prosody model of speech of a target speaker different from the source speaker. Text input to be synthesized is received, and the prosody model of speech of the target speaker is applied to the text input to select segments of the speech of the source speaker in the database to form synthesized speech of the text input. The synthesized speech of the text input is then output.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

Further, a computer storage medium may contain or store a computer readable program code such that when the computer readable program code is executed on a computer, the execution of this computer readable program code causes the computer to transmit another computer readable program code over a communications link. This communications link may use a medium that is, for example without limitation, physical or wireless.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for synthesizing speech, comprising:
providing a database of speech of a source speaker;
providing a prosody model of speech of a target speaker different from the source speaker;
receiving text input to be synthesized;
applying the prosody model of speech of the target speaker to the text input to select segments of the speech of the source speaker in the database to form synthesized speech of the text input; and
outputting the synthesized speech of the text input.

2. The computer implemented method of claim 1, wherein providing a prosody model of speech of the target speaker comprises forming the prosody model of speech of the target speaker using a speech sample of the target speaker.

3. The computer implemented method of claim 1, wherein the prosody model of speech of the target speaker reflects speech characteristics of the target speaker, and wherein the segments of the speech of the source speaker are selected to reflect the speech characteristics of the target speaker.

4. The computer implemented method of claim 1, and further comprising:
normalizing the received text input to be synthesized.

5. The computer implemented method of claim 1, and further comprising:
smoothing a pitch of the formed synthesized speech of the text input.

6. The computer implemented method of claim 1, wherein providing a database of speech of a source speaker, comprises:
providing the database of speech of the source speaker from a Concatenative Text-to-Speech speech synthesis system.

7. The computer implemented method of claim 6, wherein the Concatenative Text-to-Speech speech synthesis system comprises an off-the-shelf Concatenative Text-to-Speech speech synthesis system.

8. A system for synthesizing speech, comprising:
a database of speech of a source speaker;
a prosody model generating unit for providing a prosody model of speech of a target speaker different from the source speaker;
a receiver for receiving text input to be synthesized;
a segment selector unit for applying the prosody model of speech of the target speaker to the text input to select segments of the speech of the source speaker in the database to form synthesized speech of the text input; and
an output for outputting the synthesized speech of the text input.

9. The system of claim 8, wherein the prosody model generating unit provides the prosody model of speech of the target speaker using a speech sample of the target speaker.

10. The system of claim 8, wherein the prosody model of speech of the target speaker reflects speech characteristics of the target speaker, and wherein the segments of the speech of the source speaker are selected to reflect the speech characteristics of the target speaker.

11. The system of claim 8, and further comprising a normalizer for normalizing the received text input to be synthesized.

12. The system of claim 8, and further comprising a pitch smoothing unit for smoothing a pitch of the formed synthesized speech of the text input.

13. The system of claim 8, wherein the database of speech of a source speaker comprises a database of speech of the source speaker from a Concatenative Text-to-Speech speech synthesis system.

14. The system of claim 13, wherein the Concatenative Text-to-Speech speech synthesis system comprises an off-the-shelf Concatenative Text-to-Speech speech synthesis system.

15. A computer program product, comprising:
a computer usable storage medium having computer usable program code embodied therein for synthesizing speech, the computer program product comprising:
computer usable program code configured for providing a database of speech of a source speaker;
computer usable program code configured for providing a prosody model of speech of a target speaker different from the source speaker;
computer usable program code configured for receiving text input to be synthesized;
computer usable program code configured for applying the prosody model of speech of the target speaker to the text input to select segments of the speech of the source speaker in the database to form synthesized speech of the text input; and
computer usable program code configured for outputting the synthesized speech of the text input.

16. The computer program product of claim 15, wherein the computer usable program code configured for providing a prosody model of speech of the target speaker comprises:
computer usable program code configured for forming the prosody model of speech of the target speaker using a speech sample of the target speaker.

17. The computer program product of claim 15, wherein the prosody model of speech of the target speaker reflects speech characteristics of the target speaker, and wherein the segments of the speech of the source speaker are selected to reflect the speech characteristics of the target speaker.

18. The computer program product of claim 15, and further comprising:
computer usable program code configured for normalizing the received text input to be synthesized.

19. The computer program product of claim 15, and further comprising:
computer usable program code configured for smoothing a pitch of the formed synthesized speech of the text input.

20. The computer program product of claim 15, wherein the computer usable program code configured for providing a database of speech of a source speaker, comprises:
computer usable program code configured for providing the database of speech of the source speaker from a Concatenative Text-to-Speech speech synthesis system.
